(19) United States
(12) Patent Application Publication
(10) Pub. No.: US 2012/0265500 A1
(43) Pub. Date: Oct. 18, 2012

(54) Bravery

(75) Inventor: Ching-Min Huang, Tainan City (TW)

(73) Assignee: Ching-Min Huang, Tainan City (TW)

(21) Appl. No.: 13/088,316

(22) Filed: Apr. 15, 2011

(51) Int. Cl. G06F 17/11

(52) U.S. Cl. 703/2

(57) ABSTRACT

“BRAVERY” is an engineering calculation method that offers theoretical solutions rather than numerical solutions, and can be used to simulate the problems encountered in the engineering field, and subsequently to be used in engineering design.

### BRIEF SUMMARY

“BRAVERY” is an engineering calculation method that offers theoretical solutions rather than numerical solutions, and can be used to simulate the problems encountered in the engineering field, and subsequently to be used in engineering design.

### BACKGROUND

After the Finite Element Method was created, the engineering field entered a more mature and steady stage in terms of engineering calculation. However, the analysis results of the Finite Element Method were often unsatisfactory to engineering designers, and its accuracy has yet to be improved. “BRAVERY” is an engineering calculation method that offers theoretical solutions rather than numerical solutions, and can be used to simulate the problems encountered in the engineering field, and subsequently to be used in engineering design. The advantage of BRAVERY is that it can solve any engineering problem if engineers can precisely define their deformation curve or deformation surface.

The Finite Element Method requires that engineers must have a basic concept of the engineering problems in order to perform finite element analysis. BRAVERY also has the same requirement, or even a higher requirement regarding this concept, because engineers can only adopt the BRAVERY calculation method after they have reached an understanding of the engineering problems they are going to analyze, to a considerable degree (i.e., having already seen photos, images or data of similar problems, and can almost define the deformation curve or deformation surface).

With the Finite Element Method, if engineers have no basic concept of the engineering problems, the error in the engineering analysis results may go unseen, thus leading to the difficulty in determining whether the problem lies in errors with the engineering model, improper setting of boundary conditions, element selection error, poor mesh generation, or even a problem with the finite element software itself. Although BRAVERY has a higher requirement for engineers, its aim is the same as that of the Finite Element Method, namely, to avoid errors in the results of the engineering analysis. Simply stated, the Finite Element Method involves calculating results in a backwards direction, while BRAVERY involves predicting results in a forward direction.

### DETAILED DESCRIPTION

BRAVERY is an engineering calculation method which creates an energy equivalent formula based on the given deformation curve or deformation surface to deduce the initial hypothetical variables.

1. BRAVERY is an engineering calculation method which first calculates the axial strain and shear strain in various directions with the given deformation curve or deformation surface equation, and then establishes an equation based on the kinetic energy (K=½ mν²) or the work (W=Fd) of the load with the object's strain energy (U=½∫_{V} Eε²dV) to obtain a theoretical energy equivalent formula. Then, numerical methods are used to solve the equation in order to obtain the desired dimension variables via repeated calculations in a process based on trial and error. Finally, based on the material stress as the basis of equation control, the value of the dimension variables is obtained.
The following is an example of a calculation of a high-speed ball hitting a circular plate, with simplified theoretical derivation. Here, the impact kinetic energy can be expressed as:
K=½mξ²
Suppose that the supporting object behind the circular plate is a flexible entity; when the ball hits the circular plate from the front, the plastic deformation curve of the latter accords with the Gaussian distribution curve: μ=0. Before proportional magnification, its plastic deformation curve equation can be expressed as:
$${δ}_{A} ( x ) = \frac{{e}^{- \frac{{x}^{2}}{2 {σ}^{2}}}}{σ \sqrt{2 π}}$$
After the circular plate deforms plastically, suppose its maximum allowable midpoint deformation is δ; the proportional magnification is expressed as:
$$X = \frac{δ}{\frac{{e}^{- \frac{{x}^{2}}{2 {σ}^{2}}}}{σ \sqrt{2 π}} {\vert}_{x = 0}} = δσ \sqrt{2 π}$$
Based on the above magnification, the theoretical plastic deformation curve equation of the circular plate can be expressed as:
$${δ}_{T} ( x ) = X \frac{{e}^{- \frac{{x}^{2}}{2 {σ}^{2}}}}{σ \sqrt{2 π}} = \frac{δσ \sqrt{2 π} {e}^{- \frac{{x}^{2}}{2 {σ}^{2}}}}{σ \sqrt{2 π}} = {δe}^{- \frac{{x}^{2}}{2 {σ}^{2}}}$$
The second derivative is performed on dx to acquire the curvature κ of the plastic deformation curve, and then to obtain its radius of curvature through reciprocity. The radius of curvature of the plastic deformation curve can be expressed as:
$$ρ = \frac{1}{κ} = \frac{1}{\frac{{d}^{2}}{d {x}^{2}} ( {δe}^{- \frac{{x}^{2}}{2 {σ}^{2}}} )} = \frac{{σ}^{4} {e}^{\frac{{x}^{2}}{2 {σ}^{2}}}}{δ ( {x}^{2} - {σ}^{2} )}$$
Without considering the positive compression of the circular plate, the overall strain energy is selected in a relatively conservative way; thus the effect of compression strain ε_{γ} on the strain energy of the circular plate is ignored. Suppose the distance between the neutral axis of the circular plate and its periphery is γ; based on the above-defined radius of curvature ρ, and since the strain in the two-way symmetric directions is the same, the longitudinal and lateral strain εₓ, ε_{z} can be defined as:
$${ε}_{x} = {ε}_{z} = \frac{y}{ρ} ( 1 - v ) = \frac{y ( 1 - v )}{\frac{{σ}^{4} {e}^{\frac{{x}^{2}}{2 {σ}^{2}}}}{δ ( {x}^{2} - {σ}^{2} )}} = \frac{y δ ( {x}^{2} - {σ}^{2} ) ( 1 - v )}{{σ}^{4} {e}^{\frac{{x}^{2}}{2 {σ}^{2}}}}$$
When the ball penetrates the circular plate, the shear strain concentrates on a tiny area on the projection plane of the ball, making little contribution to the strain energy in other areas; the strain energy contribution of the shear strain on the projection plane of the ball can therefore be ignored. Hard titanium compound with evaporation coating may be used on the upper and lower surface of the substrate to resist the impact of the ball so that the circular plate can deform plastically with better effect. Based on the two-way strain of the circular plate defined in the above equation, its strain energy can be expressed as:
$$\begin{matrix}U = \frac{1}{2} {\int }_{V} E {ε}^{2} d V = \frac{1}{2} {\int }_{{V}_{i}} {E}_{i} {ε}^{2} d {V}_{i} + \\ \frac{1}{2} {\int }_{{V}_{o}} {E}_{0} {ε}^{2} d {V}_{o} + \frac{1}{2} {\int }_{{V}_{o}} {E}_{o} {ε}^{2} d {V}_{o} \\ = \frac{{E}_{i}}{2} {\int }_{{V}_{i}} {\{ \begin{matrix}{ε}_{x} \\ {ε}_{z}\end{matrix} \}}^{T} \{ \begin{matrix}{ε}_{x} \\ {ε}_{z}\end{matrix} \} d {V}_{i} + \\ {\int }_{{V}_{o}} {\{ \begin{matrix}{ε}_{x} \\ {ε}_{z}\end{matrix} \}}^{T} \{ \begin{matrix}{ε}_{x} \\ {ε}_{z}\end{matrix} \} d {V}_{o} + \\ \frac{{E}_{o}}{2} {\int }_{{V}_{o}} {\{ \begin{matrix}{ε}_{x} \\ {ε}_{z}\end{matrix} \}}^{T} \{ \begin{matrix}{ε}_{x} \\ {ε}_{z}\end{matrix} \} d {V}_{o} \\ = {E}_{i} {\int }_{- \frac{t}{2}}^{\frac{t}{2}} {\int }_{0}^{R} 2 π x \sqrt{1 + {[ \frac{d }{d x} ( δ {e}^{- \frac{{x}^{2}}{2 {σ}^{2}}} ) ]}^{2}} \\ {( \frac{y δ ( {x}^{2} - {σ}^{2} ) ( 1 - v )}{{σ}^{4} {e}^{\frac{{x}^{2}}{2 {σ}^{2}}}} )}^{2} d x d y + \\ {E}_{o} {\int }_{\frac{t}{2}}^{\frac{t}{2} + c} {\int }_{0}^{R} 2 π x \sqrt{1 + {[ \frac{d }{d x} ( δ {e}^{- \frac{{x}^{2}}{2 {σ}^{2}}} ) ]}^{2}} \\ {( \frac{y δ ( {x}^{2} - {σ}^{2} ) ( 1 - v )}{{σ}^{4} {e}^{\frac{{x}^{2}}{2 {σ}^{2}}}} )}^{2} d x d y + \\ {E}_{o} {\int }_{- \frac{t}{2} - c}^{- \frac{t}{2}} {\int }_{0}^{R} 2 π x \sqrt{1 + {[ \frac{d }{d x} ( δ {e}^{- \frac{{x}^{2}}{2 {σ}^{2}}} ) ]}^{2}} \\ {( \frac{y δ ( {x}^{2} - {σ}^{2} ) ( 1 - v )}{{σ}^{4} {e}^{\frac{{x}^{2}}{2 {σ}^{2}}}} )}^{2} d x d y \\ = \frac{{t}^{3} {E}_{i} + 2 c ( 4 {c}^{2} + 6 ct + 3 {t}^{2} ) {E}_{o}}{6} \\ {\int }_{0}^{R} π x \sqrt{1 + {[ \frac{d }{d x} ( δ {e}^{- \frac{{x}^{2}}{2 {σ}^{2}}} ) ]}^{2}} \\ {( \frac{ δ ( {x}^{2} - {σ}^{2} ) ( 1 - v )}{{σ}^{4} {e}^{\frac{{x}^{2}}{2 {σ}^{2}}}} )}^{2} d x\end{matrix}$$
According to the strain energy of the circular plate and the impact kinetic energy of the ball, an equivalent formula can be established as:
$$\frac{1}{2} {mv}^{2} = \frac{{t}^{3} {E}_{i} + 2 c ( 4 {c}^{2} + 6 ct + 3 {t}^{2} ) {E}_{o}}{6} {\int }_{0}^{R} π x \sqrt{1 + {[ \frac{d }{d x} ( {δe}^{- \frac{{x}^{2}}{2 {σ}^{2}}} ) ]}^{2}} {( \frac{ δ ( {x}^{2} - {σ}^{2} ) ( 1 - v )}{{σ}^{4} {e}^{\frac{{x}^{2}}{2 {σ}^{2}}}} )}^{2} d x$$
Through reorganization, the formula can be re-expressed as:
$${t}^{3} {E}_{i} + 2 c ( 4 {c}^{2} + 6 ct + 3 {t}^{2} ) {E}_{o} = \frac{3 {mv}^{2}}{{\int }_{0}^{R} π x \sqrt{1 + {[ \frac{d }{d x} ( {δe}^{- \frac{{x}^{2}}{2 {σ}^{2}}} ) ]}^{2} {( \frac{ δ ( {x}^{2} - {σ}^{2} ) ( 1 - v )}{{σ}^{4} {e}^{\frac{{x}^{2}}{2 {σ}^{2}}}} )}^{2} d x}}$$
The above is a theoretical calculation formula for a ball hitting a circular plate, which adopts calculation based on trial and error. The following is an example of how to solve the above equation. To avoid numerical errors, N and mm are taken.
The plastic deformation curve of the circular plate can be simulated with the Gaussian distribution curve: σ=6. The measured impact energy of AK47, M16 and .45 pistol is 2460J, 1796J and 835J, which are taken as the target to be achieved in the circular plate design. The theoretical calculation formulae related to the terms and orders of kinetic energy are then: 3 m_{c}ν_{c}²=14760J, 10776J, 5010J=14760000, 10776000, 5010000 N mm.
If a medal is capable of stopping a bullet, it will greatly enhance the bravery of those wearing it. The following therefore offers a design for a medal capable of stopping said bullet. Under given conditions, the diameter of the medal is set as 44 mm (R=22 mm), the substrate is Titanium alloy Ti6Al4V used for casting (with elastic modulus Eᵢ=113.8 GPa, Poisson's ratio ν=0.342, and yield strength σ_{y}=880 MPα), the upper and lower surface are evaporation coated (c=8 μm) with titanium carbide TiC (with elastic modulus Eₒ=448 GPa, and Mohs hardness Mohs=9.5). To determine the thickness of the medal, it is necessary to repeatedly make rectifications, and verify whether the peripheral stress value within the width of the bullet has reached the yield strength, in order to ensure that the bullet will not penetrate through the medal. Through repeated trial and error, the following three sets of calculating data were obtained:
$$A . AK 47 ( w = 7.62 mm , δ = 1.735 mm , t = 13.079 mm )$$
$${\int }_{0}^{22} π x \sqrt{1 + {[ \frac{d }{d x} ( 1.735 {e}^{- \frac{{x}^{2}}{2 \times {6}^{2}}} ) ]}^{2}} {( \frac{1.735 ( {x}^{2} - {6}^{2} ) ( 1 - 0.342 )}{{6}^{4} \times {e}^{\frac{{x}^{2}}{2 \times {6}^{2}}}} )}^{2} d x = 0.057149024133450785$$
$${t}^{3} \times 113800 + 2 \times 0.008 \times ( 4 \times {0.008}^{2} + 6 \times 0.008 \times t + 3 \times {t}^{2} ) \times 448000 = \frac{14760000}{0.057149024133450785}$$
$$t = 13.078741511388055 mm$$
$${σ}_{i , max} = \frac{y δ ( {x}^{2} - {σ}^{2} ) ( 1 - v )}{{σ}^{4} {e}^{\frac{{x}^{2}}{2 {σ}^{2}}}} \cdot {E}_{i} = \frac{\frac{13.078741511388055}{2} \times 1.735 \times [ {( \frac{7.62}{2} )}^{2} - {6}^{2} ] ( 1 - 0.342 )}{{6}^{4} \times {e}^{\frac{{( \frac{7.62}{2} )}^{2}}{2 \times {6}^{2}}}} \times 113800 = - 880.2105377936211 ≅ {σ}_{y} = 880 MPa$$
$$B . M 16 ( w = 5.56 mm , δ = 1.200 mm , t = 15.081 mm )$$
$${\int }_{0}^{22} π x \sqrt{1 + {[ \frac{d }{d x} ( 1.200 {e}^{- \frac{{x}^{2}}{2 \times {6}^{2}}} ) ]}^{2}} {( \frac{1.200 ( {x}^{2} - {6}^{2} ) ( 1 - 0.342 )}{{6}^{4} \times {e}^{\frac{{x}^{2}}{2 \times {6}^{2}}}} )}^{2} d x = 0.027264640739074912$$
$${t}^{3} \times 113800 + 2 \times 0.008 \times ( 4 \times {0.008}^{2} + 6 \times 0.008 \times t + 3 \times {t}^{2} ) \times 448000 = \frac{10776000}{0.027264640739074912}$$
$$t = 15.081134481897694 mm$$
$${σ}_{i , max} = \frac{y δ ( {x}^{2} - {σ}^{2} ) ( 1 - v )}{{σ}^{4} {e}^{\frac{{x}^{2}}{2 {σ}^{2}}}} \cdot {E}_{i} = \frac{\frac{15.081134481897694}{2} \times 1.200 \times [ {( \frac{5.56}{2} )}^{2} - {6}^{2} ] ( 1 - 0.342 )}{{6}^{4} \times {e}^{\frac{{( \frac{5.56}{2} )}^{2}}{2 \times {6}^{2}}}} \times 113800 = - 880.335276252948 ≅ {σ}_{y} = 880 MPa$$
$$C . .45 pistol ( w = 11.5 mm , δ = 16.413 mm , t = 1.788 mm )$$
$${\int }_{0}^{22} π x \sqrt{1 + {[ \frac{d }{d x} ( 16.413 {e}^{- \frac{{x}^{2}}{2 \times {6}^{2}}} ) ]}^{2}} {( \frac{16.413 ( {x}^{2} - {6}^{2} ) ( 1 - 0.342 )}{{6}^{4} \times {e}^{\frac{{x}^{2}}{2 \times {6}^{2}}}} )}^{2} d x = 6.96193561779727$$
$${t}^{3} \times 113800 + 2 \times 0.008 \times ( 4 \times {0.008}^{2} + 6 \times 0.008 \times t + 3 \times {t}^{3} ) \times 448000 = \frac{5010000}{6.96193561779727}$$
$$t = 1.7878006817497325 mm$$
$${σ}_{i , max} = \frac{y δ ( {x}^{2} - {σ}^{2} ) ( 1 - v )}{{σ}^{4} {e}^{\frac{{x}^{2}}{2 {σ}^{2}}}} \cdot {E}_{i} = \frac{\frac{1.7878006817497325}{2} \times 16.413 \times [ {( \frac{11.5}{2} )}^{2} - {6}^{2} ] ( 1 - 0.342 )}{{6}^{4} \times {e}^{\frac{{( \frac{11.5}{2} )}^{2}}{2 \times {6}^{2}}}} \times 113800 = - 879.9750808686258 ≅ {σ}_{y} = 880 MPa$$
By solving the above equations, the obtained thicknesses of medal corresponding to AK47, M16 and .45 pistol are: t=13.079 mm, 15.081 mm, and 1.788 mm, respectively. Through calculations, it is known that the bullet of an AK47 possesses more energy than that of an M16, but also that the bullet is wider than that of the latter. That is why it is harder for an AK47, but also that the bullet is wider than that of the latter. That is why it is harder for an AK47 to penetrate through the medal. A .45 pistol is mainly used for close range shooting, and its bullet has low energy and large width; this is the main reason that its penetration power is far lower than that of either an AK47 or an M16. With a reasonable thickness of medal, a .45 pistol may be taken as the design target to realize the increase in bravery. To ensure that the medal can effectively withstand the impact of a bullet, a shooting simulation is carried out with real guns and bullets. Then by correcting the gap between theory and actual measurement using statistical regression, a more complete design of bullet-stopping medal can be obtained.
Sign List
K Ball's impact kinetic energy (N mm)
m Ball's mass (g)
ν Ball's velocity (m/s)
W Work (Nmm)
F Force (N)
d Displacement (mm)
w Ball's width (mm)
U Strain energy of the circular plate (N mm)
δ_{A}(x) Plastic deformation curve equation of the circular plate (mm)
δ_{T}(x) Theoretical plastic deformation curve equation of the circular plate (mm)
X Proportion magnification of the plastic deformation; no units
σ Parameter of the plastic deformation curve (mm)
δ Maximum midpoint plastic deformation (mm)
κ Curvature of the plastic deformation curve (mm⁻)
γ Distance between the neutral axis and the periphery (mm)
ρ Curvature radius of the plastic deformation curve (mm)
εₓ,E ε_{z} Longitudinal and lateral strains of the circular plate; no units
ν Poisson's ratio of the substrate material; no units
Eᵢ Elastic modulus of the substrate material (N/mm²)
Eₒ Elastic modulus of the evaporation coated material (N/mm²)
R Design radius of the circular plate (mm)
t Substrate thickness of the circular plate (mm)
c Evaporation coated thickness of the circular plate (mm)

2. When BRAVERY is applied to materials which have already been deformed plastically (for example, pressing processing), it is necessary to evaluate its amount of plastic deformation and the residual stress in order to reduce the allowable stress value used in calculation. Otherwise, pressing may cause the material to undergo inner plastic deformation, leading to an over-estimation of the design strength, and resulting in design failure.

3. BRAVERY may be developed into engineering software for calculation purposes, to shorten the calculation time spent by engineers. The engineering software should provide, and allow manual creation of, commonly used deformation curve and deformation surface modules for engineers to quickly establish theoretical energy equivalent formulae for the engineering problems encountered, and then solve by repeated trial and error process using the built-in numerical methods to derive the value of the initial hypothetical variables. When the results are obtained, the strain and stress values of each block are calculated in accordance with the strain equation, to generate a graph for engineers to examine and verify. The definitions of the deformation curve and deformation surface are derived from the curve or curved surface, and through the equation definition for producing lines through tool functions, the deformation curve and deformation surface equation can be precisely defined.
